(19) United States
(12) Patent Application Publication
(10) Pub. No.: US 2009/0283715 A1
(43) Pub. Date: Nov. 19, 2009

(54) POLISHING SLURRY FOR CMP

(76) Inventors: Shigeru Nobe, Ibaraki (JP); Takashi Shinoda, Ibaraki (JP); Takafumi Sakurada, Ibaraki (JP); Takaaki Tanaka, Ibaraki (JP); Yoshikazu Oomori, Ibaraki (JP); Tadahiro Kimura, Ibaraki (JP); Masato Fukasawa, Ibaraki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/307,341

(22) PCT Filed: Jul. 3, 2007
(86) PCT No.: PCT/JP2007/063271

§ 371 Date: Jan. 2, 2009

(30) Foreign Application Priority Data
Jul. 4, 2006 (JP) 2006-184330

(51) Int. Cl. C09G 1/02

(52) U.S. Cl. 252/79.1

(57) ABSTRACT

The invention relates to a polishing slurry for CMP containing abrasive and a fang and seam restrainer, wherein the fang and seam restrainer is at least one selected from polycarboxylic acids, polycarboxylic acid derivatives, or carboxylic-acid-containing copolymers. According to this, provided is a polishing slurry for CMP which restrains a fang phenomenon or a seam phenomenon that an insulated film near wiring regions is excessively polished, thereby giving a high flatness to a polished face.

### TECHNICAL FIELD

The present invention relates to a polishing slurry for CMP used for polishing in the step of forming wiring of a semiconductor device, or some other step.

### BACKGROUND ART

In recent years, new finely working techniques have been developed as the integration degree and the performance of semiconductor integrated circuits (abbreviated to LSIs hereinafter) have been become high. Chemical mechanical polishing (referred to as CMP hereinafter) is one of the techniques, and is a technique that is frequently used in LSI-producing steps, in particular, for making interlayer dielectrics flat, forming metal plugs, and forming embedded wiring in the step of the formation of multilayer wiring. This technique is disclosed in, for example, the specification of U.S. Pat. No. 4,944,836.

Recently, in order to make the performance of LSIs high, the use of copper and copper alloy as electroconductive materials that are wiring materials has been attempted. However, copper or copper alloy does not easily undergo fine working based on dry etching, which is frequently used to form conventional aluminum alloy wiring. Thus, the following process (the so-called damascene process) is mainly adopted: a process of depositing a thin film of copper or copper alloy on an insulated film in which trenches are beforehand formed, so as to embed the film therein, and then removing the thin film in regions other than the trench regions by CMP, thereby forming embedded wiring. This technique is disclosed in, for example, Japanese Patent Application Laid-Open No. 02-278822.

An ordinary manner for metal CMP of polishing a metal for wiring regions, such as copper or copper alloy, is a manner of causing a polishing cloth (pad) to adhere onto a circular polishing table (platen), making the surface of the polishing cloth wet by a polishing slurry for metal while pushing a metal-film-formed surface of a substrate onto the surface of the polishing cloth, and rotating the polishing table in the state that a predetermined pressure (referred to as a polishing pressure hereinafter) is applied from the rear surface of the polishing cloth to the metal film, thereby removing convex regions of the metal film by relative mechanical friction between the polishing slurry and the convex regions of the metal film.

The metal polishing slurry used in CMP is generally composed of an oxidizer and abrasive. Furthermore, an oxidized metal dissolving agent and a protective film forming agent are optionally added thereto. According to conventional thought, a basic mechanism thereof is a mechanism that the metal film surface is first oxidized with the oxidizer and then the oxidized layer is shaven off with the abrasive. The oxidized layer on the metal surface in concave regions does not contact the polishing pad very much, so that the shaving-off effect based on the abrasive is not produced thereon. Accordingly, with the advance of the CMP, the metal layer on the convex regions is removed so that the substrate surface is made flat. Details thereof are disclosed in pp. 3460-3464 of Journal of Electrochemical Society, vol. 138, No. 11 (published in 1991).

It is stated that as a manner for making the polishing rate in CMP high, the addition of an oxidized metal dissolving agent is effective. It is interpreted that when metal oxide particles shaven off with the abrasive are dissolved into (hereinafter referred to as etched with) the polishing slurry, the shaving-off effect based on the abrasive is increased. The polishing rate based on CMP is improved by the addition of the oxidized metal dissolving agent; however, when the oxidized layer on concave regions of the metal film surface is also etched so that the metal film surface is made naked, the metal film surface is further oxidized with the oxidizer. When this is repeated, the etching of the concave regions of the metal film unfavorably advances. This causes a phenomenon that the center of the surface of embedded metal wiring is depressed into a dish-like form (referred to as dishing hereinafter) after the polishing. Thus, the flattening effect is damaged.

In order to prevent this, a protective film forming agent is added. The protective film forming agent is an agent for forming a protective film on an oxidized layer on a metal film surface to prevent the oxidized layer from being dissolved into the polishing slurry. It is desired that this protective film can be shaven off easily with the abrasive, and does not cause a decrease in the polishing rate based on CMP. Suggested is a method of using a polishing slurry for CMP containing an oxidized metal dissolving agent made of an aminoacetic acid such as glycine, or an amidosulfuric acid, and containing, as a protective film forming agent, BTA in order to restrain dishing of copper or copper alloy, and corrosion thereof when it is polished, thereby forming LSI wiring high in reliability. This technique is described in, for example, Japanese Patent Application Laid-Open No. 8-83780.

In the formation of a metallic embedment, such as the formation of damascene wiring made of copper, copper alloy or the like, or the formation of plug wiring made of tungsten or the like, the polishing rate of a silicon dioxide film which is an interlayer dielectric to be formed in regions other than the embedded regions is large in some cases. In the cases, thinning, which is a phenomenon that the thickness of the wiring together with that of the interlayer dielectric becomes small, is caused, so that the wiring resistance increases. As a result, required is a characteristic that the polishing rate of the silicon dioxide film is far smaller than that of the metal film to be polished. Thus, in order to restrain the polishing rate of silicon dioxide by anions generated by dissociation of an acid, a method of making the pH of a polishing slurry larger than pKa—0.5 is suggested. This technique is described in Japanese Patent No. 2819196.

In the meantime, beneath the metal for wiring regions, such as copper or copper alloy, a barrier conductor layer (referred to a barrier layer hereinafter), for example, a layer made of tantalum, tantalum alloy, or a tantalum compound such as tantalum nitride, is formed for preventing copper from diffusing into the interlayer dielectric or improving adhesiveness therebetween. Accordingly, it is necessary to remove the barrier layer naked in regions other than the wiring-regions, in which copper or copper alloy is to be embedded. However, the conductor of the barrier layer is higher in hardness than copper or copper alloy; therefore, a sufficient polishing rate is not gained even when polishing materials for copper or copper alloy are combined with each other. Additionally, the flatness thereof frequently becomes bad. Thus, investigations have been made about a two-stage polishing method composed of a first step of polishing the metal for wiring-regions, and a second step of polishing the barrier layer.

### DISCLOSURE OF THE INVENTION

In the two-stage polishing method, the interlayer dielectric may be required to be polished in the second step, wherein the barrier layer is polished, in order to attain the flatness. The interlayer dielectric is, for example, a silicon dioxide film, or a Low-k (low dielectric constant) film such as an organosilicate glass or entire aromatic ring type Low-k film. In this case, in accordance with the composition of the polishing slurry for the CMP, there is caused a problem (fang or seam), which is a phenomenon that after the interlayer dielectric is polished in a predetermined amount, the interlayer dielectric near the wiring regions made of copper, copper alloy or the like is depressed from the wiring-region surface without being made flat.

The fang denotes the following amount: in a stripe-form pattern region where the width of wiring metal regions is larger than that of insulated film regions (for example, the wiring metal region width: 9 μm, and the insulated film region width: 1 μm), or where the width of wiring metal regions and that of insulated film regions are each small (for example, the wiring metal region width: 0.25 μm, and the insulated film region width: 0.25 μm), the depression amount of the interlayer dielectric near the outermost of the wiring metal regions arranged in a stripe-form pattern. The seam denotes the following amount: in a stripe-form pattern region where the width of wiring metal regions and that of insulated film regions are each large (for example, the wiring metal region width: 100 μm, and the insulated film region width: 100 μm), the depression amount of the interlayer dielectric near the wiring metal regions.

In light of the above-mentioned problems, the invention provides a polishing slurry for CMP which restrains a phenomenon (fang or seam) that an insulated film near wiring regions is excessively polished, thereby giving a high flatness to a polished surface.

The invention is according to the following.

(1) A polishing slurry for CMP, comprising abrasive and a fang and seam restrainer, wherein the fang and seam restrainer is at least one selected from polycarboxylic acids, polycarboxylic acid derivatives and carboxylic-acid-containing copolymers.

(2) The polishing slurry for CMP according to item (1), which is used for polishing a metal film and an insulated film.

(3) The polishing slurry for CMP according to item (1) or (2), wherein the abrasive is at least one selected from silica, alumina, ceria, titania, zirconia, germania and modified products thereof.

(4) The polishing slurry for CMP according to any one of items (1) to (3), which contains an organic solvent, an oxidized metal dissolving agent and water.

(5) The polishing slurry for CMP according to any one of items (1) to (4), which further includes a metal oxidizing agent.

(6) The polishing slurry for CMP according to any one of items (1) to (5), which further includes a metal inhibitor.

The disclosure of the present application is related to the subject matter described in Japanese Patent Application No. 2006-184330 filed on Jul. 4, 2006, and the disclosed contents thereof are incorporated herein by reference.

### BEST MODE FOR CARRYING OUT THE INVENTION

The polishing slurry for CMP of the invention includes therein a fang and seam restrainer which is at least one selected from polycarboxylic acids, polycarboxylic acid derivatives, and carboxylic-acid-containing copolymers, and further includes abrasive. In general, the polishing slurry preferably contains an organic solvent, an oxidized metal dissolving agent, and water, and more preferably contains a metal oxidizing agent and a metal inhibitor.

The fang and seam restrainer in the polishing slurry of the invention is at least one selected from polycarboxylic acids, polycarboxylic acid derivatives, and carboxylic-acid-containing copolymers. Examples of the polycarboxylic acids or polycarboxylic acid derivatives include polyacrylic acid, polymethacrylic acid, polyaspartic acid, polyglutamic acid, polymalic acid, polymaleic acid, polyitaconic acid and polyfumaric acid, and salts and esters of these polycarboxylic acids. Examples of the carboxylic-acid-containing copolymers include copolymers each made from carboxylic acids, copolymers each made from carboxylic acid derivatives, copolymers each made from a carboxylic acid and a carboxylic acid derivative, carboxylic acid/vinyl alcohol copolymers, carboxylic acid/sulfonic acid copolymers and carboxylic acid/acrylamide copolymers, and salts and esters thereof. In anyone of the carboxylic-acid-containing copolymers, the amount of the carboxylic acid component is preferably from 5 to 100% by mole. These may be used alone or in the form of a mixture of two or more thereof. Of these acids, polyacrylic acid is preferred.

The weight-average molecular weight of the fang and seam restrainer is preferably 500 or more, more preferably 1500 or more, in particular preferably 5000 or more. The upper limit of the weight-average molecular weight is not particularly limited, and is preferably 5000000 or less from the viewpoint of the solubility thereof. The weight-average molecular weight may be measured by gel permeation chromatography, using a calibration curve of polystyrene.

The blend amount of the fang and seam restrainer is preferably from 0.001 to 10 g, more preferably from 0.005 to 5 g for 100 g of the entire components. If this blend amount is too large, the polishing rate of the barrier conductor layer tends to lower. If the amount is too small, the fang and seam restraining effect tends to deteriorate.

The organic solvent in the polishing slurry for CMP of the invention is not particularly limited, and is preferably a solvent miscible with water at will. Examples of the organic solvent include glycols, glycol monoethers, glycol diethers, alcohols, carbonates, lactones, ethers, ketones, and other compounds such as phenol, dimethylformamide, n-methylpyrrolidone, ethyl acetate, ethyl lactate, and sulfolane. The solvent is preferably at least one selected from glycol monoethers, alcohols, and carbonates. For example, propylene glycol monopropyl ether, or 2-ethyl-1,3-hexanediol is preferred.

The blend amount of the organic solvent is preferably from 0.1 to 95 g, more preferably from 0.2 to 50 g, in particular preferably from 0.5 to 10 g for 100 g of the total of the entire components. If the blend amount is less than 0.1 g, the wettability of the polishing slurry to a substrate is low. If the amount is more than 95 g, the amount is not preferred for the production process since the solvent may catch fire.

The oxidized metal dissolving agent in the invention is not particularly limited, and examples thereof include organic acids, organic acid esters, ammonium salts of organic acids, inorganic acids, and ammonium salts of inorganic acids. Of these agents, the following are preferred for electroconductive materials made mainly of metal since a practical CMP rate is kept while the agents can effectively restrain the etching rate: formic acid, malonic acid, malic acid, tartaric acid, citric acid, salicylic acid, and adipic acid. Besides, sulfuric acid is preferred therefor from the viewpoint of a high CMP rate. These may be used alone or in the form of a mixture of two or more thereof.

The blend amount of the oxidized metal dissolving agent is preferably from 0.001 to 20 g, more preferably from 0.002 to 10 g, in particular preferably from 0.005 to 5 g for 100 g of the total amount of the entire components. If the blend amount is less than 0.001 g, the polishing rate tends to be low. If the amount is more than 20 g, etching is not easily restrained so that the polished face tends to become rough. It is sufficient that water out of the above-mentioned components constitutes the balance. No problem is caused as far as water is contained in the slurry.

The abrasive in the invention is not particularly limited, and is, for example, inorganic abrasive made of silica, colloidal silica, alumina, zirconia, ceria, titania, germania, silicon carbide or the like, organic abrasive made of polystyrene, polyacrylic acid, polyvinyl chloride or the like, or a modified product of the abrasive. Preferred are silica, alumina, zirconia, ceria, titania, and germania. In particular, preferred are colloidal silica and colloidal alumina having an average particle diameter of 200 nm or less, which are good in dispersion stability in the polishing slurry and are each a material wherein the generation number of scratches generated by CMP is small. More preferred are colloidal silica and colloidal alumina having an average particle diameter of 100 nm or less. Moreover, preferred are particles where primary particles are aggregated only in a number of less than 2 on average, and more preferred are particles where primary particles are aggregated only in a number of less than 1.2 on average. Furthermore, the standard deviation of the average particle size distribution is preferably 10 nm or less, more preferably 5 nm or less. These may be used alone or in the form of a mixture of two or more thereof.

The blend amount of the abrasive is preferably from 0.01 to 50 g, more preferably from 0.02 to 30 g, in particular preferably from 0.05 to 20 g for 100 g of the total amount of the entire components. If the blend amount is less than 0.01 g, the polishing rate tends to be low. If the amount is more than 50 g, many scratches tend to be generated.

A metal oxidizing agent may be added to the polishing slurry for CMP of the invention. Examples of the metal oxidizing agent include hydrogen peroxide (H₂O₂), nitric acid, potassium periodate, hypochlorous acid, and ozone water. Of these agents, hydrogen peroxide is particularly preferred. These may be used alone or in the form of a mixture of two or more thereof. When the substrate is a silicon substrate containing elements for integrated circuits, it is undesired that the substrate is polluted with an alkali metal, an alkaline earth metal, a halide, or the like; therefore, the agent is desirably an oxidizing agent which does not contain any nonvolatile component. However, about ozone water, the composition thereof is intensely varied with time; thus, hydrogen peroxide is most suitable. However, an oxidizing agent containing a nonvolatile component is allowable when the substrate to which the invention is to be applied is a glass substrate containing no semiconductor element, or the like.

The blend amount of the oxidizing agent is preferably from 0.01 to 50 g, more preferably from 0.02 to 30 g, in particular preferably from 0.05 to 15 g for 100 g of the total amount of the entire components. If the blend amount is less than 0.01 g, metal is insufficiently oxidized so that the CMP rate tends to be low. If the amount is more than 50 g, the polished face tends to become rough.

A metal inhibitor may be added to the polishing slurry for CMP of the invention. Examples of the metal inhibitor include 2-mercaptobenzothiazole, 1,2,3-triazole, 1,2,4-triazole, 3-amino-1H-1,2,4-triazole, benzotriazole, 1-hydroxybenzotriazole, 1-dihydroxypropylbenzotriazole, 2,3-dicarboxypropylbenzotriazole, 4-hydroxybenzotriazole, 4-carboxyl(-1H-)benzotriazole, 4-carboxyl(-1H-)benzotriazole methyl ester, 4-carboxyl(-1H-)benzotriazole butyl ester, 4-carboxyl(-1H-)benzotriazole octyl ester, 5-hexylbenzotriazole, [1,2,3-benzotriazolyl-1-methyl][1,2,4-triazolyl-1-methyl][2-et hylhexyl]amine, tolyltriazole, naphthotriazole, bis[(1-benzotriazolyl)methyl]phosphonate.

Other examples thereof include pyrimidines, which have a pyrimidine skeleton, 1,2,4-triazolo[1,5-a]pyrimidine, 1,3,4,6,7,8-hexahydro-2H-pyrimido[1,2-a]pyrimidine, 1,3-diphenyl-pyrimidine-2,4,6-trione, 1,4,5,6-tetrahydropyrimidine, 2,4,5,6-tetraminopyrimidinesulfate, 2,4,5-trihydroxylpyrimidine, 2,4,6-triaminopyrimidine, 2,4,6-trichloropyrimidine, 2,4,6-trimethoxypyrimidine, 2,4,6-triphenylpyrimidine, 2,4-diamino-6-hydroxypyrimidine, 2,4-diaminopyrimidine, 2-acetoamidepyrimidine, 2-aminopyrimidine, 2-methyl-5,7-diphenyl-(1,2,4)triazolo(1,5-a)pyrimidine, 2-methylsulfanyl-5,7-diphenyl-(1,2,4)triazolo(1,5-a)pyrimidine, 2-methylsulfanyl-5,7-diphenyl-4,7-dihydro-(1,2,4)triazolo(1,5-A)pyrimidine, and 4-aminopyrazolo[3,4-d]pyrimidine. These may be used alone or in the form of a mixture of two or more thereof.

The blend amount of the metal inhibitor is preferably from 0 to 10 g, more preferably from 0.001 to 5 g, in particular preferably from 0.002 to 2 g for 100 g of the total amount of the entire components. If this blend amount is more than 10 g, the polishing rate tends to become low.

It is preferred to use the polishing slurry for CMP of the invention to polish a metal film and an insulated film. The electroconductive material of the metal film is, for example, a material made mainly of copper, a copper alloy, a copper oxide or an oxide of a copper alloy, tungsten, a tungsten alloy, silver, gold and any other metal.

The barrier layer is formed to prevent the diffusion of the electroconductive material into the insulated film and improve the adhesiveness between the insulated film and the electroconductive material, and is, for example, a barrier layer made of at least one selected from tungsten, tungsten nitride, tungsten alloys, other tungsten compounds, titanium, titanium nitride, titanium alloys, other titanium compounds, tantalum, tantalum nitride, tantalum alloys, other tantalum compounds, ruthenium, and other ruthenium compounds, or a laminated film containing this barrier layer.

The insulated film is, for example, a silicon-based film or an organic polymer film. The silicon-based film is, for example, a silica-based film made of silicon dioxide, fluorosilicate glass, an organosilicate glass obtained from trimethylsilane or dimethoxydimethylsilane as a starting material, silicon oxynitride, silsesquioxane hydride or the like; silicon carbide; or silicon nitride. The organic polymer film is, for example, an entire aromatic type low-dielectric-constant interlayer dielectric.

The polishing slurry for CMP of the invention may be used to polish a metal film and an insulated film simultaneously or separately as well as to polish a metal film and a silicon compound film formed on a semiconductor substrate as described above. The slurry may be used to polish, for example, an inorganic insulated film formed on a wired board having predetermined wires, made of a silicon oxide film, glass, silicon nitride or the like, an optical glass such as a photomask, lens or prism, an inorganic electroconductive film made of ITO or the like, an optical integrated circuit, optical switching element or optical waveguide made of glass and a crystalline material, an end face of an optical fiber, an optical monocrystal such as a scintillator or the like, a solid laser monocrystal, an LED sapphire substrate for blue laser, a semiconductor monocrystal such as SiC, GaP or GaAs, a glass substrate for magnetic disc, or a substrate of a magnetic head.

### EXAMPLES

The invention will be described by way of the following examples. The invention is not limited by these examples.

About each of 854 CMP patterns (thickness of its interlayer dielectric: 500 nm) manufactured by ATDF as copper-wiring-clad substrates, its copper film on regions other than grooves was polished by a known CMP method using a known polishing slurry for copper CMP (first polishing step). In this way, silicon substrates were prepared.

<Polishing Conditions>

Polishing apparatus: polishing machine for single-surface CMP (product name: MIRRA, manufactured by Applied Materials Inc.)

Polishing pad: suede-like foamed polyurethane resin

Table rotation number: 93 rotations/min.

Head rotation number: 87 rotations/min.

Polishing pressure: 2 psi (about 14 kPa)

Supply amount of the polishing slurry: 200 mL/min.

<Method for Evaluating Depression Amounts (Seam and Fang) of Interlayer Dielectric Near Wiring>

Seam: polishing slurries of Examples 1 and 2 and item (1) of Comparative Example 1 described below were each used to polish one of the copper-wiring-clad substrates (second polishing step). After the polishing, a probe-type profile microscope was used to measure the surface shape of its stripe-form pattern region, wherein wiring metal regions each 100 μm in width and insulated film regions each 100 μm in width were arranged to be alternated with each other, and then the depression amount (seam) of the interlayer dielectric near the wiring metal regions was evaluated.

Fang: about each of the copper-wiring-clad substrates after the second polishing step, the probe-type profile microscope was used to measure the surface shape of its stripe-form pattern region, wherein wiring metal regions each 9 μm in width and insulated film regions each 1 μm in width were arranged to be alternated with each other, and then the depression amount (fang) of the interlayer dielectric was evaluated near the outermost of the wiring metal regions arranged in the stripe form.

<Method for Evaluating Film Thickness of Insulated Film Regions>

About each of the copper-wiring-clad substrates after the second polishing step, the center film thickness of the insulated film regions of the stripe-form pattern region, wherein the wiring metal regions each 100 μm in width and the insulated film regions each 100 μm in width were arranged to be alternated with each other, was measured with an optical thickness meter. The film thickness before the polishing was 500 nm.

### Example 1

### (1) Preparation of a Polishing Slurry for CMP

Collected were 6.0 parts by mass of colloidal silica having an average particle diameter of 60 nm, 0.1 part by mass of benzotriazole, 0.2 part by mass of malonic acid, 5.0 parts by mass of propylene glycol monopropyl ether, 0.06 part by mass of polyacrylic acid (weight-average molecular weight: 50000), and 88.64 parts by mass of pure water. The components were sufficiently stirred and mixed with each other. Next, this mixed solution and hydrogen peroxide (30% solution thereof in water, extra pure reagent) were mixed with each other at a ratio by mass of 99.0:1.0 to prepare a polishing slurry.

### (2) Polishing Results

The polishing slurry in the item (1) was used to polish one of the copper-wiring-clad substrates for 70 seconds. The seam was 5 nm, and the fang was 5 nm. The film thickness of the interlayer dielectric was 450 nm.

### Example 2

### (1) Preparation of a Polishing Slurry for CMP

Collected were 6.0 parts by mass of colloidal silica having an average particle diameter of 40 nm, 0.1 part by mass of 1,2,4-triazole, 0.2 part by mass of citric acid, 5.0 parts by mass of propylene glycol monopropyl ether, 0.02 part by mass of polymetacrylic acid (weight-average molecular weight: 10000), and 88.68 parts by mass of pure water. The components were sufficiently stirred and mixed with each other. Next, this mixed solution and hydrogen peroxide (30% solution thereof in water, extra pure reagent) were mixed with each other at a ratio by mass of 99.0:1.0 to prepare a polishing slurry.

### (2) Polishing Results

The polishing slurry in the item (1) was used to polish one of the copper-wiring-clad substrates for 70 seconds. The seam was 10 nm, and the fang was 5 nm. The film thickness of the interlayer dielectric was 455 nm.

### Comparative Example 1

### (1) Preparation of a Polishing Slurry for CMP

Collected were 6.0 parts by mass of colloidal silica having an average particle diameter of 60 nm, 0.1 part by mass of benzotriazole, 0.2 part by mass of malonic acid, 5.0 parts by mass of propylene glycol monopropyl ether, and 88.7 parts by mass of pure water. The components were sufficiently stirred and mixed with each other. Next, this mixed solution and hydrogen peroxide (30% solution thereof in water, extra pure reagent) were mixed with each other at a ratio by mass of 99.0:1.0 to prepare a polishing slurry.

### (2) Polishing Results

The polishing slurry in the item (1) was used to polish one of the copper-wiring-clad substrates for 70 seconds. The seam was 40 nm, and the fang was 20 nm. The film thickness of the interlayer dielectric was 450 nm.

It has been understood that a polished face having a high flatness can be obtained according to the polishing slurry for CMP of the invention.

### INDUSTRIAL APPLICABILITY

It has been made possible to provide a polishing slurry for CMP which restrains a phenomenon that an insulated film near wiring regions is excessively polished (fang or seam), thereby giving a high flatness to a polished face.

1. A polishing slurry for CMP, comprising abrasive and a fang and seam restrainer, wherein the fang and seam restrainer is at least one selected from polycarboxylic acids, polycarboxylic acid derivatives and carboxylic-acid-containing copolymers.

2. The polishing slurry for CMP according to claim 1, which is used for polishing a metal film and an insulated film.

3. The polishing slurry for CMP according to claim 1, wherein the abrasive is at least one selected from silica, alumina, ceria, titania, zirconia, germania and modified products thereof.

4. The polishing slurry for CMP according to claim 1, which comprises an organic solvent, an oxidized metal dissolving agent and water.

5. The polishing slurry for CMP according to claim 1, which further comprises a metal oxidizing agent.

6. The polishing slurry for CMP according to claim 1, which further comprises a metal inhibitor.
